(19) United States
(12) Patent Application Publication
(10) Pub. No.: US 2003/0144767 A1
(43) Pub. Date: Jul. 31, 2003

(54) System and method for determining the load state of a motor vehicle

(76) Inventors: Jost Brachert, Ditzingen (DE); Jost Brachert, Ditzingen (DE); Ulrich Hessmert, Schwieberdingen (DE); Norbert Polzin, Zaberfeld (DE); Thomas Sauter, Remseck (DE); Helmut Wandel, Markgroeningen (DE)

Correspondence Address: KENYON & KENYON, ONE BROADWAY, NEW YORK, NY, 10004, US

(21) Appl. No.: 10/220,407

(22) PCT Filed: Dec. 22, 2001
(86) PCT No.: PCT/DE01/04905

(30) Foreign Application Priority Data
Dec. 30, 2000 (DE) 100 65 766.4

(51) Int. Cl. G06F 17/00

(52) U.S. Cl. 701/1; 701/124

(57) ABSTRACT

A system for assessing the load state of a motor vehicle having at least one wheel (12) includes at least one sensor device (10), which records a quantity proportional to the vehicle weight and emits a signal (Si, Sa) representing the quantity, and an assessment system (14), which processes the signal (Si, Sa) representing the recorded quantity, and assesses a load state of the vehicle according to the result of the processing. According to the present invention, the sensor device (10) is a wheel-force sensor device (10) assigned to the at least one wheel (12) which records, as a value proportional to the vehicle weight, the center of tire force of the respective wheel (12) acting essentially between the road surface and the center of tire surface. The present invention also relates to a corresponding method.

The present invention relates to a system for assessing the load state of a motor vehicle having at least one wheel, including: at least one sensor device which records a quantity proportional to the vehicle weight and emits a signal representing the quantity, and an assessment system which processes the signal representing the recorded quantity, and according to the results of the processing, assesses a load state of the vehicle.

The present invention also relates to a method for assessing the load state of a motor vehicle having at least one wheel, preferably for being executed by a system according to the present invention, which method includes the following steps: Recording a quantity proportional to the vehicle weight, processing the recorded quantity, and assessing the load state of the vehicle according to the result of the processing.

### BACKGROUND INFORMATION

Motor vehicles are normally assigned a maximum load or a maximum gross weight, exceeding which cancels the operating permit for the vehicle. This serves to guarantee the traffic safety of vehicles, since at inadmissible loads, there exists a threat that devices on the vehicle that are important to the operation may fail. In addition, the operating behavior of vehicles changes with the load. For vehicles that are loaded inadmissibly, driving situations may become critical which may be handled without a problem if the load state is admissible.

In this connection, not only is exceeding of the admissible gross weight critical, but also an admissible roof loading, at which the admissible gross weight is not exceeded. The overall center of gravity of the vehicle is shifted away from the plane of the road surface by a roof loading of that kind, so that the vehicle may be caused to tip over by dynamic driving maneuvers such as driving along s-shaped curves.

Therefore, knowledge of the load state is of great importance for ensuring traffic safety. To be sure, a driver who has not loaded his vehicle at all does not have to worry about his load state, but situations occur often enough, just about generally in the case of commercial vehicles, but also in the case of transporting with passenger cars, in which the driver is no longer able adequately to estimate the loading of his motor vehicle.

For commercial vehicles a system is known from the related art which determines the current commercial vehicle weight, by pressure sensors in the air pressure spring systems of the commercial vehicle.

This device has the disadvantage that its application is limited to vehicles having air pressure spring systems, which excludes its use in most passenger cars. Besides, considerable inaccuracies may arise by calculating the vehicle weight from the gas pressure, such as by temperature influences or by deterioration-related influences on the gas.

In connection with advantageously usable sensors, it is also known that different tire manufacturers are planning on the future use of so-called intelligent tires. With these, new sensors and evaluating circuits may be mounted directly on the tire. The use of such tires allows additional functions, such as the measurement of the torque at the tire, transversely and lengthwise to the direction of travel, of tire pressure or of tire temperature. In this connection, for example, tires may be provided where in each tire magnetized areas or strips are incorporated, preferably having field lines running in the circumferential direction. The magnetization is carried out in sections, for instance, always in the same direction, but having opposite orientations, i.e. having alternate polarity. The magnetized strips preferably run in the rim flange area and in the tire contact area. Therefore, the measured value detectors rotate at wheel speed. Corresponding measuring sensors are preferably mounted fixed to the body at two or more points different in the rotational direction, and are also at a different radial distance from the axis of rotation. In this manner, an inner measuring signal and an outer measuring signal may be obtained. Rotation of the tire may then be detected by the changing polarity of the measuring signal or the measuring signals in the circumferential direction. The wheel speed can, for example, be calculated from the tire-tread circumference and the change with time of the inner measuring signal and the outer measuring signal. Furthermore, conclusions may be drawn from the measuring signals concerning the deformation of the tire, and thus concerning the forces acting between the tire and the road surface.

It has also been proposed before to put sensors in the wheel bearing, this setup being able to be made in the rotating as well as in the static part of the wheel bearing. For instance, the sensors may be realized as microsensors in the form of microswitch arrays. The sensors positioned at the movable part of the wheel bearing may measure, for example, forces and accelerations as well as wheel speed. These data are compared to electronically stored base patterns or to data from a like or similar microsensor which is mounted on the fixed part of the wheel bearing.

### SUMMARY OF THE INVENTION

The present invention builds up on a system of this type, in that the sensor device is a wheel-force sensor device assigned to the at least one wheel, which records, as a value proportional to the vehicle weight, the center of tire force of the respective wheel acting essentially between the road surface and the center of tire surface. By recording the center of tire force, which is a force component acting orthogonally to the center of tire surface, the vehicle weight may directly be determined exactly, that is, without further recalculation from a gas pressure. In this context, on the one hand, the exceeding of the admissible gross weight may be detected, and on the other hand, from a great exceeding of the vehicle's empty weight one may conclude that there has been a shifting of the center of gravity away from the plane of the road surface and that there is an inadmissible loading of the roof.

According to an advantageous further refinement of the present invention, the driver may be informed via an output unit, such as an onboard computer, when a predetermined vehicle weight threshold value has been exceeded, that driving operation is inadmissible if the recorded payload is on the vehicle roof, and not, perhaps, in the trunk. Furthermore, from another point of view of the present invention, the driver may indicate, via an input device, the location of the vehicle at which the vehicle payload is present, so that the system may come to a conclusion, from the recorded vehicle weight, by comparison with a first predetermined vehicle weight threshold value, as an assessment of the load state, that the vehicle gross weight has been exceeded, and, by taking into consideration a driver input, possibly by comparison with a second vehicle weight threshold value, it may conclude that an admissible roof load has been exceeded.

Basically, in a system according to the present invention it is sufficient to provide only one wheel with a wheel-force sensor device, since the distribution of the vehicle gross weight to the individual center of tire points is essentially predefined by the vehicle's geometry. However, the vehicle weight may be determined substantially more accurately if at least two wheels lying opposite to each other in the transverse direction of the vehicle, but preferably every wheel of the vehicle have a wheel-force sensor assigned to them.

In the case in which a sensor device is assigned to each wheel of the vehicle, it may be determined, perhaps with regard to an unloaded state, and with the aid of the change in the recorded center of tire force of each wheel, whether the load is on the roof or perhaps in the trunk, since the center of tire forces change differently at the same payload weight, because of different locations where the payload has been placed.

A tire sensor device and/or a wheel bearing sensor device may advantageously be considered as the wheel-force sensor device. These sensor devices have the advantage, on the one hand, that they may record center of tire forces very accurately, without any considerable interfering influences, since the location where the recording takes place is very close to the effective location of the recorded force. On the other hand, these sensor devices, in addition to the center of tire force may also be used to ascertain a wheel speed, and thus the vehicle speed. If such a sensor device is assigned to all wheels, that is, driven and non-driven wheels, additional quantities characterizing the driving conditions may be ascertained, such as wheel slip or a difference speed between left and right vehicle wheels.

Although one may infer that cornering is taking place by recording wheel speeds at left and right wheels, the system may include alternatively or additionally a steering sensor device for increasing accuracy, which is in a position to detect the operation of the steering wheel, preferably a steering wheel angle and/or steering angle.

In order to record changes in quantities over time, it is advantageous if the system includes a time-measuring device. It will be evident to people skilled in the art that a time-measuring device may preferably be a clock, but not necessarily so. Any device from which the elapsing of time may be inferred is practical for this application. For instance, a time may also be ascertained from the knowledge of the vehicle speed and the route traveled.

In order to ascertain changes of variables over time, it is of advantage if the system includes a memory device. In it may be stored the at least one center of tire force and/or at least one recorded wheel speed and/or a recorded steering wheel angle and/or steering angle and/or points in time of recording, which are assigned to the recorded values.

For example, the assessment system may ascertain a change over time of the at least one center of tire force and a change over time of turn-in speed, and assess the load state according to the ascertained results. This represents an assessment of the load state according to the dynamic performance of the vehicle, which permits not only a very accurate assessment of the weight, but also an assessment with respect to the location where the payload has been placed, since the operating dynamics are influenced by the position of the vehicle's center of gravity above the road surface.

Thus, from one point of view of the present invention, the assessment system may determine from the vehicle dynamics at least approximately a vehicle mass distribution, preferably the mass moment of inertia of the vehicle.

Furthermore, the assessment system according to the present invention may also determine a transverse acceleration, preferably from the wheel speed of non-driven wheels, and from a yaw rate. In that way, one may infer the rollover tendency from the transverse acceleration and the assessed vehicle payload.

This rollover tendency may be estimated particularly accurately when the assessment system determines the height of the vehicle center of gravity above the road surface and assesses the load state according to the result of the determination. The height of the vehicle center of gravity may, for instance, be determined by using a characteristics map, which may be stored in the memory unit, and which gives a relationship between the change over time of the ascertained center of tire force of the at least one wheel, the change over time of a turn-in speed and the height of the vehicle's center of gravity above the road surface.

Additionally, from the data available to it, the assessment system may also determine the radius of curve of the curve path the vehicle is actually traversing. An example is given further below as to how acceleration and radius of curve may be ascertained.

Beyond merely assessing the load state, the assessment system may increase the traffic safety of the vehicle by emitting a command signal according to the assessed load state, the system further including an actuator which influences an operating state of the motor vehicle according to the command signal.

For example, the command signal may include a maximum admissible transverse acceleration ascertainable from the load state and/or a maximum admissible cornering speed. The command signal may thus effect a limitation of the transverse acceleration and/or the cornering speed to a corresponding maximum value and thereby, for instance, safely prevent a rollover of the vehicle. As possible interventions in the load state of the motor vehicle, for example, a change in engine power and/or a change in the wheel braking pressure of at least one wheel of the motor vehicle come into consideration. According to one point of view of the present invention, (the change in) the engine power may be carried out by resetting the point of ignition and/or by changing the throttle valve position and/or by changing the amount of fuel injected. In this context, the system may be implemented using the lowest number of components if the assessment system and/or the actuator is/are assigned to a device for controlling and/or regulating the driving behavior of a motor vehicle, such as an anti-lock system, an ASR system or an ESP system. This particularly includes the case in which the named devices are part of the equipment.

In other words, the present invention relates to a system for controlling and/or regulating the driving behavior of a motor vehicle having at least one tire and/or one wheel, in the tire and/or on the wheel, especially on the wheel bearing, a force sensor being mounted, and as a function of the output signals of the force sensor the cornering speed and/or the transverse acceleration of the vehicle is limited. In this context, as a function of the output signals of the force sensor, a mass value may be ascertained which represents the vehicle mass or the vehicle mass distribution, and, as a function of the mass value, the cornering speed and/or the transverse acceleration of the vehicle may be limited.

The present invention builds upon the method according to the present invention in that, in the recording step, a center of tire force of the at least one wheel, acting essentially between the road surface and the center of tire surface, is recorded as a quantity proportional to the vehicle weight. In the method according to the present invention, which is particularly suitable for being executed by the system according to the present invention, the advantages of the system according to the present invention are also achieved, for which reason we refer to the above system description for a supplementary explanation of the method.

As described above, the vehicle weight may be determined and compared to a corresponding threshold value from the center of tire force recorded at the at least one wheel. Center of tire forces are preferably recorded at all the wheels. From this may also be determined both the location of the payload in the vehicle and subsequently the exceeding of an admissible payload, depending on the location (roof or trunk).

According to further advantageous aspects of the present invention, the recording step may include the recording of the wheel speed of at least one wheel and/or the recording of the operation of the steering wheel, preferably of a steering wheel angle and/or a steering angle and/or the recording of the time or of quantities connected with time. The assessment of the load state may advantageously be made according to the ascertainment results of the change with time of the at least one center of tire force and the change with time of a turn-in speed.

Using the vehicle dynamics thus ascertainable, one may further ascertain a vehicle mass distribution, preferably a mass moment of inertia, of the vehicle.

With respect to ascertaining an inadmissible roof load, it is of advantage if the method also includes the ascertainment of the height of the vehicle's center of gravity above the road surface, the assessment of the load state being made according to the result of this ascertainment.

The assessment of the height of the vehicle's center of gravity may, for instance, be made as described above, with the aid of a suitable characteristics map.

The height of the vehicle's center of gravity above the road surface may additionally be ascertained from the transverse acceleration and the change with time of the at least one center of tire force, as a result of which it is of advantage if the method includes the ascertainment of the transverse acceleration. The height of the vehicle's center of gravity may in this case be simply ascertained, using the law of levers.

The radius of curve traveled may be used as a further measure of an impending rollover, or rather for a centrifugal force during travel on a curve, so that it is favorable if the method includes the ascertainment of a radius of curve. In order to improve traffic safety, the method may alternatively or additionally include the influencing of an operating state of the motor vehicle according to the result of the assessment of the load state, preferably using consideration of the radius of curve.

Within the framework of this influencing step, the transverse acceleration and or the cornering speed may be limited to a corresponding maximum value, thereby preventing rollover of the vehicle.

If equipment for controlling and/or regulating the driving behavior of the motor vehicle is provided, such as an anti-lock system, an ASR system or an ESP system, it is then favorable, if one wishes to avoid additional components and modules in the vehicle, for the influencing step to be carried out by this equipment or these pieces of equipment.

### BRIEF DESCRIPTION OF THE DRAWINGS

The present invention is explained in greater detail below, in the light of the corresponding drawings. The Figures show:

FIG. 1 a block diagram of the system according to the present invention;

FIG. 2 a flow diagram of a method according to the present invention for ascertaining an overloading of the vehicle;

FIG. 3 a flow diagram of an alternative or additional method according to the present invention for ascertaining a critical roof load of the vehicle;

FIG. 4 a part of a tire equipped with a tire sidewall sensor;

FIG. 5 exemplary signal patterns of the tire sidewall sensor shown in FIG. 3.

### DESCRIPTION OF THE EXEMPLARY EMBODIMENTS

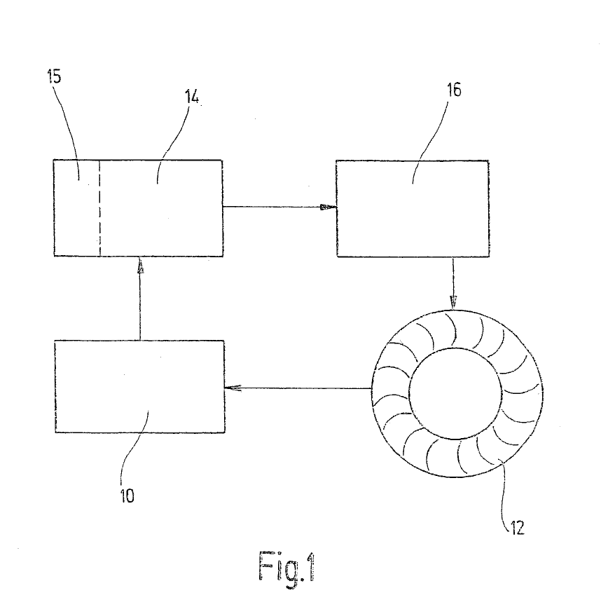

FIG. 1 shows a block diagram of the system according to the present invention. A sensor device 10 is assigned to a wheel 12, the wheel 12 being shown as representative of the wheels of a vehicle. Sensor device 10 is connected to an assessment system 14 for processing signals from sensor device 10. Assessment system 14 includes a memory device 15 for storing recorded values. Assessment system 14 is also connected to an actuator 16. This actuator, in turn, is assigned to wheel 12.

In the example shown, sensor device 10 here records the center of tire force and the wheel speed of wheel 12. The recordings resulting from this are transmitted to assessment system 14 for further processing. For example, the wheel contact forces mentioned are ascertained in assessment system 14 from a detected deformation of the tire. This can be accomplished by using a characteristic curve stored in a memory unit.

In assessment system 14, the load state of the vehicle may be assessed from the center of tire forces of the individual wheels by comparison with a vehicle weight threshold value.

Assessment system 14 ascertains a maximum cornering speed and/or a maximum transverse acceleration as a function of the assessed load state. In the light of a comparison of an instantaneous cornering speed and/or a maximum transverse acceleration with the maximum cornering speed and/or the maximum transverse acceleration, assessment system 14 generates an appropriate command signal.

This signal may be transmitted to actuator 16 so that influence can be exerted on the operating state of the vehicle, especially on wheel 12, as a function of the signal. Such an influence can be exerted by a brake application on individual wheels, change of the throttle valve setting on the engine, by changing the quantity of fuel injection, the injection time and/or the injection duration, by injection blank-out and/or by changing the point of ignition.

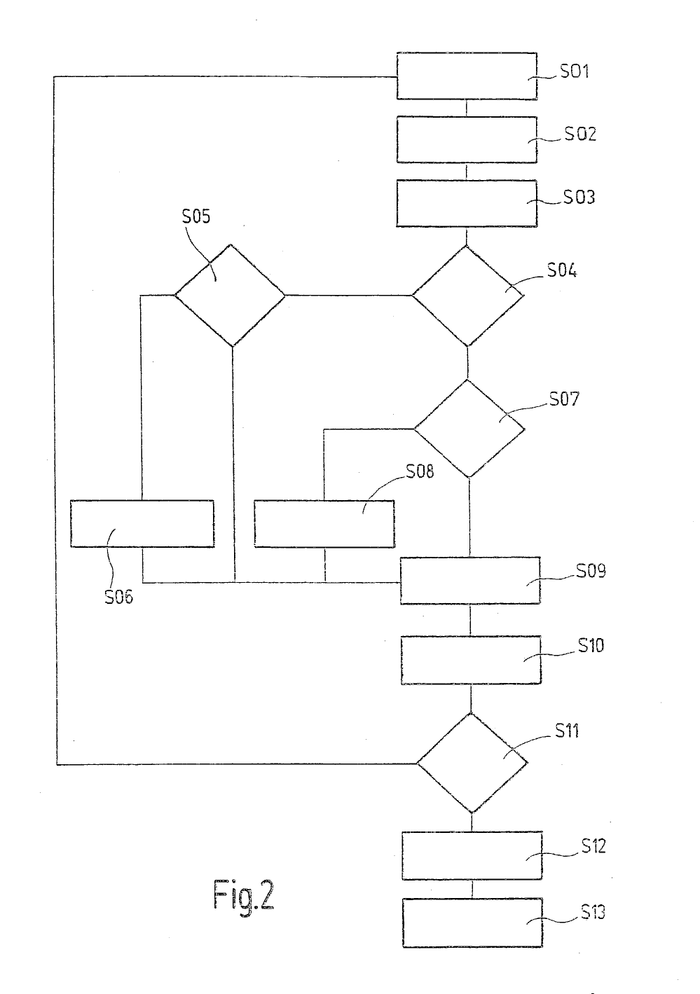

FIG. 2 shows a flow diagram of a specific embodiment of the method according to the present invention within the framework of the present invention, the load state of the vehicle being assessed with respect to overloading, and, as a function of the assessment result, a stabilizing intervention in the vehicle operation is made by the system according to the present invention. The meaning of the individual steps is first of all indicated below:

S01: recording of a deformation on each tire.

S02: calculation of the normal force of the tire on the road surface from the detected deformation.

S03: determination of the payload weight of the vehicle from the sum of the center of tire forces of all wheels.

S04: determination of the location of the payload on the vehicle.

S05: comparison of the payload weight determined in step S03 with a predetermined trunk load threshold value.

S06: emission of a warning signal to the driver.

S07: comparison of the payload weight determined in step S03 with a predetermined roof load threshold value.

S08: emission of a warning signal to the driver.

S09: ascertainment of a maximum admissible transverse acceleration.

S10: ascertainment of an instantaneous actual transverse acceleration.

S11: comparison of the instantaneous actual transverse acceleration with the maximum admissible transverse acceleration ascertained in step S09.

S12: ascertainment of the suitable measures for an operating intervention for the limitation of the instantaneous actual transverse acceleration to the maximum admissible transverse acceleration, and, if necessary, of the wheels on which these are to be carried out.

S13: carrying out the measures.

The process sequence shown in FIG. 2 can take place this way, or in a similar way in a rear-wheel driven or a front-wheel driven vehicle. In step S01 a deformation of a tire is recorded.

A center of tire force is ascertained from the deformation in step S02 for each wheel. This is done using characteristic curves stored in a memory unit, which give the relationship of tire deformation to center of tire force. A wheel speed is also ascertained for each wheel.

In step S03 the payload weight of the vehicle is determined from the sum of the ascertained center of tire forces of each wheel, and in step S04 the location of the payload is determined.

If it is determined in step S04 that the payload is in the trunk, in step S05 the payload weight determined in step S03 is compared with a trunk load threshold value. The predetermined trunk load threshold value may perhaps be the maximum admissible gross weight of the vehicle, a value close to this, or an experimentally determined value, at which the driving dynamics properties of the vehicle change to such an extent, that the vehicle may be put into critical driving situations in a considerably easier fashion. Thus an overloading of the vehicle may be recognized. If the trunk load threshold value is exceeded, a corresponding warning signal to the driver is emitted in step S06.

If it is determined in step S04 that the payload is on the roof, in step S07 the payload weight determined in step S03 is compared with a roof load threshold value. The predetermined roof load threshold value may be specified by the vehicle manufacturer with respect to stability or driving dynamics criteria. Thus, an excessively high roof load of the vehicle may be determined. If the roof load threshold value is exceeded, a corresponding warning signal to the driver is emitted in step S08.

In the following step S09, while considering the ascertained payload weight, a maximum admissible transverse acceleration is calculated, at which the vehicle is still safely controllable. At this point it should be expressly pointed out that, according to the present invention, alternatively or additionally to the maximum admissible transverse acceleration, a maximum admissible cornering speed may also be calculated. This maximum value or these maximum values are subsequently used for a driving dynamics regulation.

In step S10 an actual transverse acceleration of the vehicle is ascertained. In this context, the actual transverse acceleration may, for instance, be determined by using the wheel speeds and the yaw rate of the vehicle. It is given, for example, by:

AY_B=ω·VMNA

where AY_B is the actual transverse acceleration, ω the yaw rate and VMNA the average speed of the non-driven wheels. The yaw rate ω of a vehicle may, for instance, be calculated from the characteristic vehicle dimensions and the average vehicle speed as follows:

a.) For rear-wheel driven vehicles:

$$ω = \frac{DV\_G}{\# SPURW \cdot cos ( δ )} \cdot \frac{1}{1 + cl \cdot {VMNA}^{2}} ,$$

with cos(δ)=1−0.5·δ²

and

$$= DV\_G \cdot \frac{\# WHEELBASE}{\# SPURW \cdot VMNA} = \frac{DV\_G}{VMNA} \cdot c2$$

b.) For front-wheel driven vehicles:

$$ω = \frac{DV\_G}{\# SPURW} \cdot \frac{1}{1 + cl \cdot {VMNA}^{2}}$$

where c1 and c2 are constants, DV_G is the differential speed of the non-driven wheels to be ascertained from the corresponding wheel speeds, #WHEELBASE is the wheelbase of the vehicle and #SPURW is the tire tread width.

In step S11 a comparison between the actual transverse acceleration and the maximum admissible transverse acceleration ascertained in step S09 is carried out.

If the comparison shows that the actual transverse acceleration exceeds the maximum admissible transverse acceleration, then, in the subsequent method steps, a stabilizing intervention is made in the vehicle operating state.

In step S12 suitable measures are ascertained for limiting the actual transverse acceleration to the maximum admissible transverse acceleration. This may be accomplished by a reduction in speed, for instance, in such a way that first the wheels are selected which are to be additionally submitted to a braking force. Then, in the next step, the magnitude of the braking force application is calculated.

Finally, the measures ascertained in step 12 are carried out in step 13 by corresponding corrective interventions, such as on hydraulic valves.

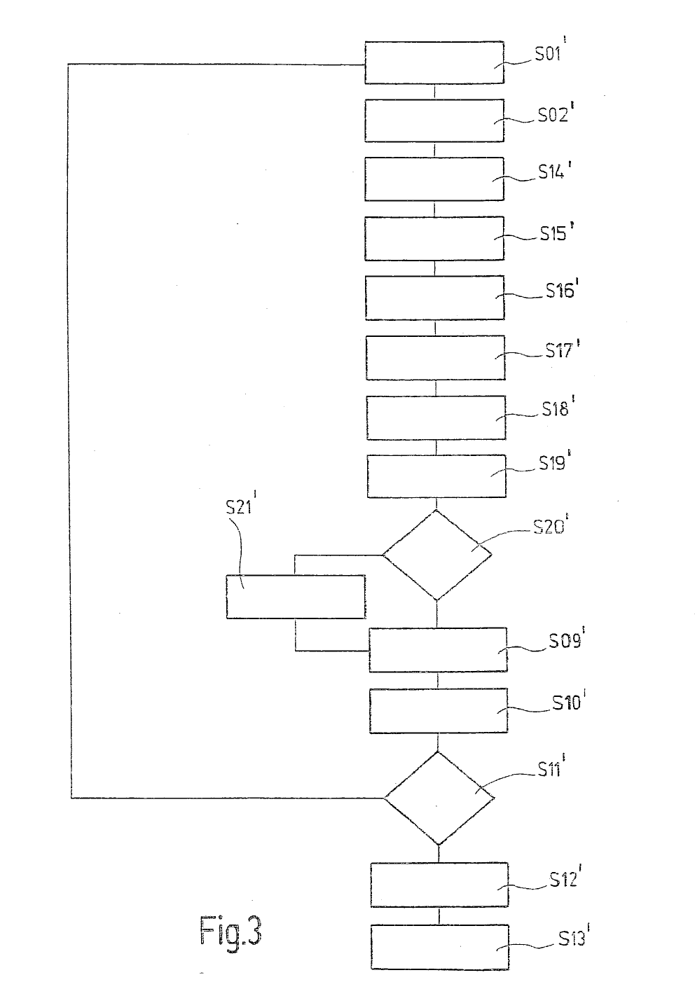

FIG. 3 shows a flow diagram of a method for ascertaining a critical roof load of the vehicle, and, as a function of this, an intervention carried out on the operating state of the vehicle. By contrast to the ones in FIG. 2, the reference numerals are shown having primes. Identical reference numerals are used here for the same method steps. In this context, the method steps denote in detail:

S01′: recording of a deformation on each tire.

S02′: calculation of the normal force of each tire on the road surface from the detected deformation.

S14′: storing current center of tire forces ascertained in step together with the appertaining times of recording.

S15′: recording of a steering wheel angle.

S16′: storing current steering wheel angle ascertained in step S15′ together with the appertaining time of recording.

S17′: determining a change with time of the center of tire forces of all wheels.

S18′: determining the change with time of the steering wheel angle.

S19′: determining a height of the vehicle center of gravity above the road surface, according to a characteristics map, as a function of the change with time of the center of tire forces of all wheels and the change with time of the steering wheel angle.

S20′: comparison of the vehicle center of gravity determined in step S19′ with a predetermined center of gravity threshold value.

S21′: emitting a warning signal to the driver.

S09′: ascertaining a maximum admissible transverse acceleration.

S10′: ascertaining an instantaneous actual transverse acceleration.

S11′: comparing the instantaneous actual transverse acceleration with the maximum admissible transverse acceleration ascertained in step S091.

S12′: ascertaining the suitable measures for an operating intervention for the limitation of the instantaneous actual transverse acceleration to the maximum admissible transverse acceleration, and, if necessary, of the wheels on which these are to be carried out.

S13′: carrying out the measures.

In the following, only those method steps are explained which differ from those of the method shown in FIG. 2. With respect to the remaining method steps, we refer to the description of FIG. 2.

In step S14′, the instantaneous center of tire forces ascertained in step S02′ are stored together with the appertaining times of recording, so that they will be available for a later calculation of a change over time.

In step S15′ an instantaneous steering wheel angle is recorded in order to obtain data on a turn-in speed, i.e. on a change over time of the steering wheel angle. Instead of the steering wheel angle, a steering angle may also be recorded. In order to obtain a good relationship between the center of tire forces and the turn-in, the steering wheel angle should be recorded in as simultaneous a fashion as possible with the center of tire forces.

In step S16′, analogously to the center of tire forces in step S14′, the steering wheel angle recorded in step S02′ is stored together with its time of being recorded. For the purpose of unloading the memory device, old values no longer needed may be deleted, if necessary.

Subsequently, in step S17′ the change over time of the center of tire forces of all wheels are determined. To simplify further processing, the changes over time at the individual wheels may be combined to a single change variable.

Similarly, the change over time of the steering wheel angle is determined in step S18′.

Subsequently, the height of the vehicle center of gravity above the road surface may be determined in one step S19′, according to a characteristics map, as a function of the change over time of the center of tire forces of all the wheels and the change over time of the steering wheel angle. By comparing the height of the vehicle's center of gravity determined in step S19′ with a predetermined center of gravity height threshold value in step S20′, the load state of the vehicle with respect to a critical roof load may be assessed. When the predetermined center of gravity height threshold value is exceeded, a corresponding warning signal to the driver is emitted.

In step S09′, as in step S09, of the method as in FIG. 2, a maximum admissible transverse acceleration is ascertained, only this time under consideration of the height of the vehicle's center of gravity determined in step S19′.

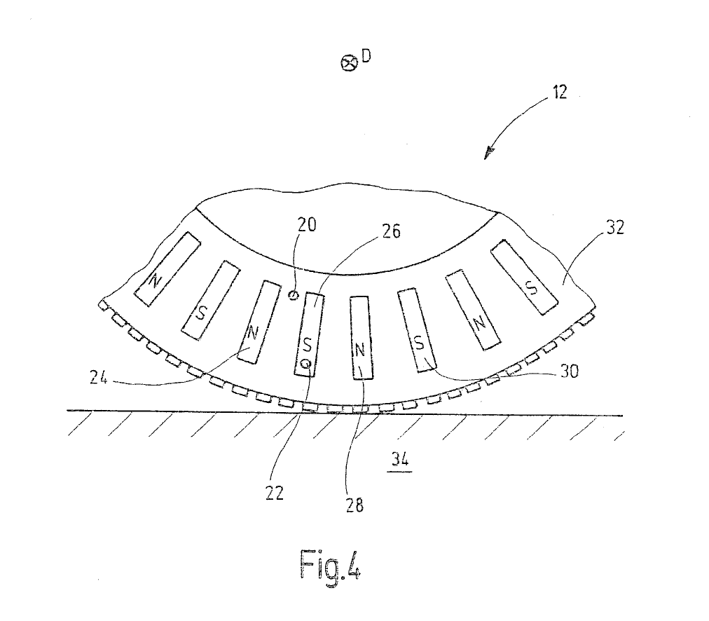

In FIG. 4, a section from a tire 32 that is mounted on wheel 12 is depicted with a so-called tire/sidewall sensor device 20, 22, 24, 26, 28, 30 viewed in the direction of axis of rotation D of tire 32. Tire/sidewall sensor device 20 includes two sensor installations 20, 22 that are permanently mounted on the vehicle body at two different points along the direction of rotation. Furthermore, sensors 20, 22 each have a different radial distance from the axis of rotation of wheel 32. The sidewall of tire 32 is provided with a multiplicity of magnetized areas functioning as measured-value transmitters 24, 26, 28, 30 (strips) running essentially in a radial direction with respect to the wheel's axis of rotation and preferably having field lines running in a circumferential direction. The magnetized areas have alternating magnetic polarity.

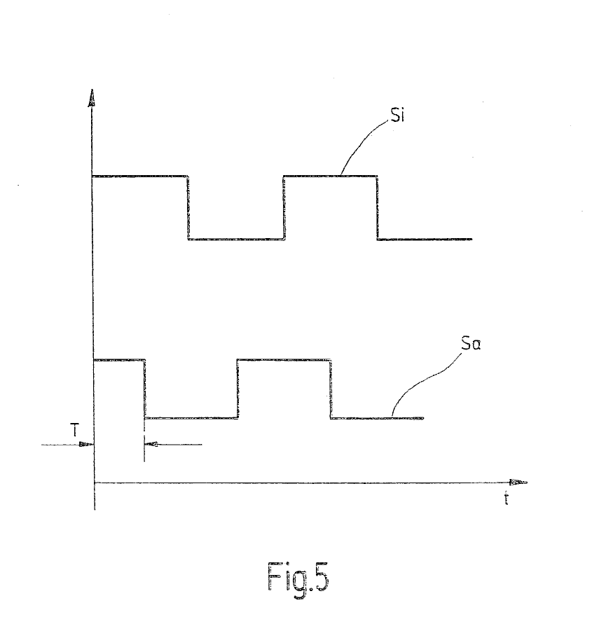

FIG. 5 shows the curves of signal Si of sensor device 20 from FIG. 4 located toward the inside, that is, closer to axis of rotation D of wheel 12, and of signal Sa of sensor device 22 from FIG. 4, which is toward the outside, that is, further away from the axis of rotation of wheel 12. A rotation of wheel 32 is detected via the alternating polarity of measuring signals Si and Sa. The wheel speed, for example, may be calculated from the rolling (tire tread) circumference and the change over time of signals Si and Sa. The torsion of wheel 32 may be determined via phase shifts between the signals allowing e.g. wheel forces to be measured directly. Within the context of the present invention, it is particularly advantageous to determine the center of tire force of tire 32 on road 34 in FIG. 4, since the tendency of the motor vehicle wheels to lift off may be inferred from this center of tire force in accordance with the present invention. A center of tire force of a tire that is standing still may be ascertained from the tire deformation.

The preceding description of the exemplary embodiments according to the present invention is for illustrative purposes only, and is not meant to restrict the invention. Various changes and modifications are possible within the framework of the present invention, without leaving the scope of the present invention and its equivalents.

What is claimed is:

1. A system for assessing the load state of a motor vehicle having at least one wheel (12), comprising:
at least one sensor device (10) which records a quantity proportional to the vehicle weight and emits a signal (Si, Sa) representing the quantity, and
an assessment system (14), which processes the signal (Si, Sa) representing the recorded quantity, and assesses a load state of the vehicle according to the result of the processing.
wherein the sensor device (10) is a wheel-force sensor device (10) assigned to the at least one wheel (12) which records, as a value proportional to the vehicle weight, the center of tire force of the respective wheel (12) acting essentially between the road surface and the center of tire surface.

2. The system as recited in claim 1, wherein a wheel force sensor device (10) is assigned to each of at least two wheels (12) which are opposite to each other in the transverse direction of the vehicle, and preferably to each wheel (12) of the vehicle.

3. The system as recited in claim 1 or 2, wherein the at least one wheel force sensor device (10) is a tire sensor device (20, 22, 24, 26, 28, 30) and/or a wheel bearing sensor device.

4. The system as recited in one of the preceding claims, wherein it includes a memory device (15) for storing the at least one ascertained center of tire force and/or the at least one recorded wheel speed and/or a recorded steering wheel angle and/or a steering angle and/or the times of recording appertaining to the recorded values.

5. The system as recited in one of the preceding claims, wherein the assessment system (14) may ascertain a change a change over time of the at least one center of tire force and a change over time of a turn-in speed, and assess the load state according to the ascertainment results.

6. The system as recited in one of the preceding claims, wherein the assessment system (14) determines the height of the vehicle's center of gravity above the road surface, and assesses the load state according to the results of the determination.

7. The system as recited in one of the preceding claims, wherein
the assessment system (14) emits a command signal according to the assessed load state and
the system also includes an actuator (16) that influences an operating state of the motor vehicle in accordance with the command signal.

8. The system as recited in one of the preceding claims, wherein the command signal has the effect of limiting the transverse acceleration and/or the cornering speed to a corresponding maximum value.

9. The system as recited in one of the preceding claims, wherein the assessment system (14) and/or the actuator (16) is/are assigned to equipment for controlling and/or regulating the driving behavior of a motor vehicle, such as an anti-lock system, an ASR system or an ESP system.

10. A system for controlling and/or regulating the driving behavior of a motor vehicle having at least one tire and/or one wheel (12), a force sensor (20, 22) being mounted in the tire and/or on the wheel (12), particularly on the wheel bearing, and the cornering speed and/or the transverse acceleration of the vehicle being limited as a function of the output signals of the force sensors (20, 22).

11. The system as recited in claim 10, wherein a mass value is ascertained, representing the vehicle mass or the vehicle mass distribution, as a function of the output signals (Si, Sa) of the power sensors (20, 22), and the cornering speed and/or the transverse acceleration of the vehicle is/are limited as a function of the mass value.

12. A system for assessing the load state of a motor vehicle having at least one wheel (12), which includes the following steps:
recording a quantity (S01, S02; S01′, S02′) proportional to the vehicle weight,
processing the recorded quantity (S03, S04; S14′ through S19′), and
assessing a load state of the vehicle according to the result of the processing (S05, S07; S20′). wherein in the recording step (S01, S02; S01′, S02′), a center of tire force acting essentially between the road surface and the center of tire surface of the at least one wheel (12) is recorded as the quantity proportional to the vehicle weight.

13. The method as recited in claim 12, wherein it further includes the following steps:
ascertaining a change over time of the at least one ascertained center of tire force (S17′), and
ascertaining a change over time of a turn-in speed (S18′).

14. The method according to one of claims 12 or 13, wherein it further includes a step for ascertaining the height of the vehicle's center of gravity above the road surface (S19′), the assessment of the load state being made according to the result of this ascertainment (S20′).

15. The method as recited in one of claims 12 through 14, wherein it further includes a step for ascertaining a transverse acceleration of the vehicle (S09, S10; S09′, S10′).

16. The method as recited in one of claims 12 through 15, wherein it further includes a step for ascertaining a cornering radius of the curved path currently being traversed by the vehicle.

17. The method as recited in one of claims 12 through 16, wherein it further includes the following step:
influencing an operating state of the motor vehicle according to the result of assessing the load state (S12, S13; S12′, S13′), preferably under consideration of the radius of curve.

18. The method as recited in one of claims 12 through 17, wherein the influencing step includes a limiting of the transverse acceleration and/or the cornering speed to a corresponding maximum value (S12; S12′).

19. The method as recited in one of claims 12 through 18, wherein the influencing step is carried out by equipment for controlling and/or regulating the driving behavior of a motor vehicle, such as an anti-lock system, an ASR system or an ESP system.
